(19) United States
(12) Patent Application Publication
(10) Pub. No.: US 2019/0119509 A1
(43) Pub. Date: Apr. 25, 2019

(54) INFRARED BLOCKING COMPOSITION, METHODS OF FORMING, AND THE INFRARED LAYER FORMED THEREFROM

(71) Applicant: SABIC GLOBAL TECHNOLOGIES B.V., Bergen op Zoom (NL)

(72) Inventors: Liping Zheng, Shanghai (CN); Mahari Tjahjadi, Shanghai (CN); Hengjie Lai, Shanghai (CN)

(21) Appl. No.: 16/089,561

(22) PCT Filed: Jun. 6, 2017
(86) PCT No.: PCT/IB2017/053334

§ 371 Date: Sep. 28, 2018

Related U.S. Application Data
(60) Provisional application No. 62/350,346, filed on Jun. 15, 2016.

(51) Int. Cl. C09D 5/32; C09D 4/00; C09D 183/04; C09D 133/04; C08J 7/04; G02B 5/20

(52) U.S. Cl. CPC C09D 5/32; C09D 4/00; C09D 183/04; C08K 2003/2258; C08J 7/047; G02B 5/208; C09D 133/04

(57) ABSTRACT

In an embodiment, an infrared blocking composition comprises 60 to 98 wt % of a curable prepolymer based on a total weight of the curable prepolymer and an infrared blocking agent; 2 to 40 wt % of the infrared blocking agent based on a total weight of the curable prepolymer and the infrared blocking agent; wherein the infrared blocking agent comprises indium tin oxide, antimony tin oxide, fluorine tin oxide, tungsten oxide, or a combination comprising at least one of the foregoing.

### CROSS-REFERENCE TO RELATED APPLICATION

This application claims the benefit of U.S. Provisional Patent Application Ser. No. 62/350,346 filed Jun. 15, 2017. The related application is incorporated herein in its entirety by reference.

### TECHNICAL FIELD

This disclosures relates to an infrared blocking composition, methods of forming, and the infrared layer formed therefrom.

### BACKGROUND

Plastic glazings offer many advantages as compared to conventional glass glazings. These advantages include, for example, increased fracture resistance, a reduced weight, and for use in vehicles, an increased occupant safety in the event of traffic accidents and a lower fuel consumption. Unfortunately though, plastic glazings experience an increased permeability to infrared radiation as compared to glass glazings, which ultimately result in an increased heating of interior spaces such as those of buildings and vehicles. The increased temperature in the interior space reduces the comfort for the occupants or inhabitants and may entail increased demands on the air conditioning, which in turn increases the energy consumption.

Thus, there is a need for new technologies, for example, with passive design solutions, which would lead to a reduced solar heat load interior spaces.

### BRIEF SUMMARY

Disclosed herein is an infrared blocking composition, a method of forming, and an infrared layer formed therefrom.

In an embodiment, an infrared blocking composition comprises 60 to 95 weight percent (wt %), or 60 to 98 wt % of a curable prepolymer based on a total weight of the curable prepolymer and an infrared blocking agent; 2 to 40 wt %, or 5 to 40 wt % of the infrared blocking agent based on a total weight of the curable prepolymer and the infrared blocking agent; wherein the infrared blocking agent comprises indium tin oxide, antimony tin oxide, fluorine tin oxide, tungsten oxide, or a combination comprising at least one of the foregoing.

In an embodiment, an infrared blocking layer is formed from the composition.

In an embodiment, a layered structure comprises the infrared blocking layer.

In an embodiment, an article comprises the infrared blocking layer.

In an embodiment, a method of forming the layered structure comprises disposing the infrared blocking composition on the polymeric substrate; and curing the infrared blocking composition to form the layered structure.

In another embodiment, a method of forming the layered structure comprises disposing the infrared blocking composition on a removable substrate; and curing the infrared blocking composition to form the infrared blocking layer; removing the infrared blocking layer; and laminating the infrared blocking layer onto the polymeric substrate to form the layered structure.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is an illustrative example of an embodiment of the multilayer structure;

FIG. 2 is an illustrative example of an embodiment of the multilayer structure;

FIG. 3 is a graphical illustration of the transmission and the reflection spectroscopy data over the visible infrared range of Example 5; and

FIG. 4 is a graphical illustration of the haze and IR blocking as a function of cesium tungsten oxide (CTO) concentration of Examples 6-13.

### DETAILED DESCRIPTION

The greatest part of solar energy is apportioned to both the visible and near infrared wavelengths of 300 to 2,500 nanometers (nm). Solar radiation that penetrates a plastic glazing and enters an internal space can be emitted as long-wave thermal radiation having a wavelength of 5 to 15 micrometers. While plastic glazings are transparent to the visible and near infrared wavelengths, they are not transparent to the long-wave thermal radiation and the thermal radiation cannot radiate outwards of the internal space, resulting in a greenhouse effect. In order to reduce the heat buildup in internal spaces, the amount of solar energy that penetrates the plastic glazing should be minimized. It was surprisingly discovered that an infrared blocking layer comprising a polymer matrix and an infrared blocking agent could result in a decrease in infrared transmission though a plastic glazing. The infrared blocking layer can block much of the light in the infrared wavelength, but is able to maintain a high visible light transmission at same time.

The infrared blocking layer comprises an infrared blocking agent and a polymer matrix. The infrared blocking agent can comprise indium tin oxide, antimony tin oxide, fluorine tin oxide, tungsten oxide, or a combination comprising at least one of the foregoing.

The infrared blocking agent can comprise a tungsten oxide. The tungsten oxide can have the formula W_{y}O_{z}, wherein z/y can be 2.20 to 2.99. The tungsten oxide can have the formula MₓW_{y}O_{z}, wherein x/y can be 0.001 to 1 (for example, 0.001 to 1.000), z/y can be 2.2 to 3.0, and wherein M can comprise H, He, an alkali metal, an alkaline-earth metal, a rare earth metal, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, or a combination comprising at least one of the foregoing. Specifically, M can comprise H, Cs, Rb, K, Tl, In, Ba, Li, Ca, Sr, Fe, Sn, or a combination comprising at least one of the foregoing. More specifically, M can comprise Cs. The tungsten oxide can comprise potassium tungsten oxide (such as K(WO₃)₃), rubidium tungsten oxide (such as Rb(WO₃)₃), cesium tungsten oxide (such as Cs(WO₃)₃), thallium tungsten oxide (such as Tl(WO₃)₃), or a combination comprising one or more of the foregoing. The tungsten oxide can comprise cesium tungsten oxide. A ratio of cesium to tungsten can be 0.20 to 0.33.

The infrared blocking agent can comprise one or both of regular shaped particles and irregular shaped particles. The infrared blocking agent can comprise particles that are spherical, irregular, flakes, whiskers, cylinders, and the like, or a combination comprising at least one of the foregoing. The infrared blocking agent can comprise particles that have an average largest dimension of less than or equal to 200 nm, less than or equal to 75 nm, or 5 to 100 nm. 90 to 100 wt %, or greater than or equal to 95 wt %, or greater than or equal to 99 wt % of the infrared blocking agent particles can have an average largest dimension of less than or equal to 200 nm.

The infrared layer polymer matrix can comprise a polyurethane, a polyacrylate, or a combination comprising at least one of the foregoing. The infrared layer polymer matrix can comprise the silicon-based acrylate, for example, comprising a polysiloxane such as polydimethylsiloxane. The infrared layer polymer matrix can be a UV cured polymer matrix.

The infrared blocking layer can comprise an ultraviolet light absorbing agent. Examples of ultraviolet light absorbing agents include hydroxybenzophenones (e.g., 2-hydroxy-4-n-octoxy benzophenone), hydroxybenzotriazines, cyanoacrylates, oxanilides, benzoxazinones (e.g., 2,2′-(1,4-phenylene)bis(4H-3,1-benzoxazin-4-one, commercially available under the trade name CYASORB UV-3638 from Cytec), aryl salicylates, hydroxybenzotriazoles (e.g., 2-(2-hydroxy-5-methylphenyl)benzotriazole, 2-(2-hydroxy-5-tert-octylphenyl)benzotriazole, and 2-(2H-benzotriazol-2-yl)-4-(1,1,3,3-tetramethylbutyl)-phenol, commercially available under the trade name CYASORB 5411 from Cytec), or combinations comprising at least one of the foregoing. The ultraviolet light blocking agent can comprise a benzotriazole, a 2-hydroxyphenyltriazine, a benzoate, a hydroxybenzophenone, or a combination comprising at least one of the foregoing. The ultraviolet light absorbing agent can be present in an amount of 0.001 to 10 wt %, or 5 to 9 wt %, 0.01 to 1 wt %, or 0.1 to 0.5 wt %, or 0.15 to 0.4 wt %, based upon the total weight the infrared blocking layer.

The infrared blocking layer can comprise 2 to 40 wt %, or 5 to 35 wt %, or 12 to 30 wt %, or 15 to 28 wt % of the infrared blocking agent based on the total weight of the layer. The infrared blocking layer can comprise 1 to 20 wt %, or 2 to 15 wt % of the infrared blocking agent based on the total weight of the layer.

The infrared blocking layer can have a thickness of 1 to 100 micrometers, or 35 to 75 micrometers, or 1 to 10 micrometers, or less than or equal to 10 micrometers. The infrared blocking layer can have a thickness of 30 to 100 micrometers, for example, if prepared by a coextrusion method. The infrared blocking layer can have a thickness of 5 to 10 micrometers, for example, if prepared by a coating method.

The infrared blocking layer can have a 5B adhesion, for example, if prepared by a coating method. The adhesion can be determined in accordance with ASTM D3002-07, where 5B is the rating for the best adhesion down to 0B that is the lowest adhesion rating. When the infrared blocking layer is prepared by a coextrusion method, the infrared blocking layer can exhibit no delamination.

The infrared blocking layer can have a visible light transmission (Tvis) capable of transmitting 20 to 85%, or 35 to 55% of the visible light as determined in accordance with ISO-9050.

The infrared blocking layer can have a total solar transmission (Tts) of greater than or equal to 50%, or greater than or equal to 70%, or greater than or equal to 75%, or 50 to 95% as determined in accordance with ISO-9050. The infrared blocking layer can have a total solar transmission of less than or equal to 95%, or less than or equal to 75%, or less than or equal to 70%, or less than or equal to 50%, or 40 to 60%, or 20 to 50% as determined in accordance with ISO-9050.

The infrared blocking layer can have a haze of less than or equal to 8%, or less than or equal to 5%, or less than or equal to 3%, or less than or equal to 1%, or 0.01 to 5% as determined in accordance with ASTM D-1003-00, Procedure A, measured, e.g., using a HAZE-GUARD DUAL from BYK-Gardner, using an integrating sphere (0°/diffuse geometry), wherein the spectral sensitivity conforms to the CIE standard spectral value under standard lamp D65.

The infrared blocking layer can have an infrared blocking of greater than or equal to 80%, or greater than or equal to 90%, or 90 to 99%. The IR blocking is equal to (the total IR transmittance (0.42456) minus the sum of the transmittance over the wavelengths of 780 to 2,500 nm) divided by the total IR transmittance times 100. It is noted that the value of 0.42456 is the infrared portion from overall solar spectrum energy based on a normalized relative spectra distribution of global solar radiation (direct+diffuse) for an air mass of 1.5.

A multilayer structure can comprise a polymeric substrate and the infrared blocking layer. The infrared blocking layer can be located on one or both of a first and second surface of the polymeric substrate. The infrared blocking layer can be in direct contact with the polymeric substrate.

The multilayer structure can comprise a first polymeric substrate comprising a first infrared blocking layer disposed on at least a first surface of the first polymeric substrate; a second polymeric substrate comprising a second infrared blocking layer disposed on at least a second surface of the first polymeric substrate; and a gap located in between the first polymeric substrate and the second polymeric substrate. The gap can comprise a gas (such as air or an inert gas), a vacuum, an aerogel, and the like.

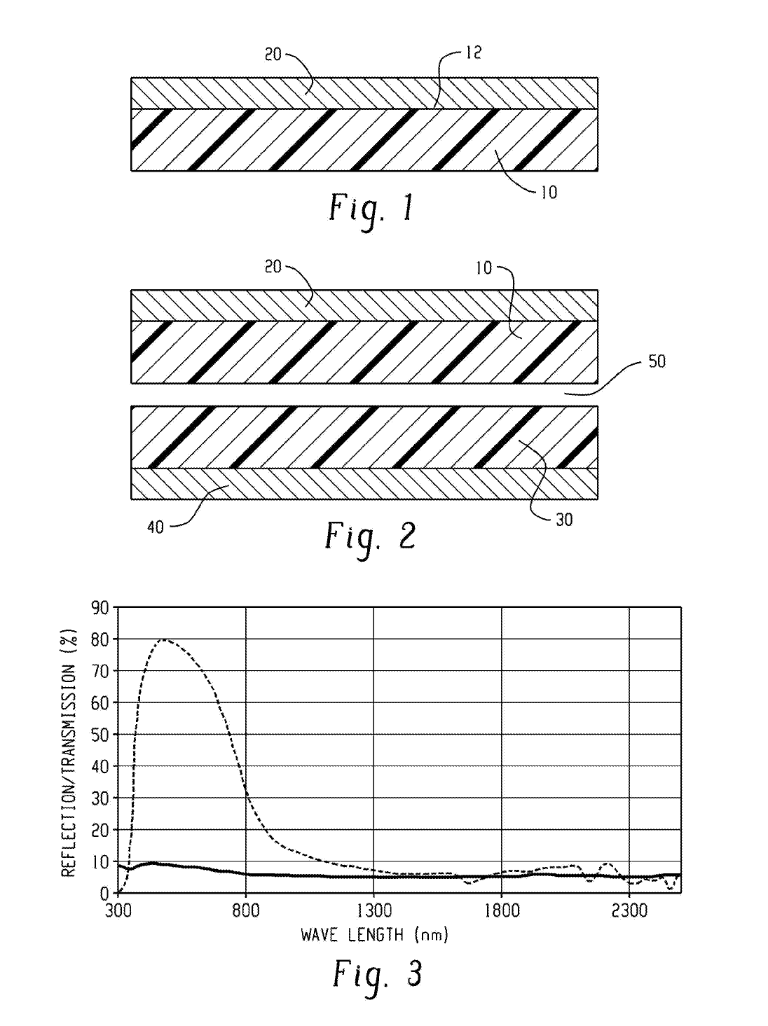

FIG. 1 and FIG. 2 are illustrative examples of embodiments of the multilayer structure. FIG. 1 illustrates that the multilayer structure can comprise polymeric substrate 10 and infrared blocking layer 20 and further illustrates that infrared blocking layer 20 can be located on first surface 12 of polymeric substrate 10. Infrared blocking layer 20 can be in direct contact with first surface 12 of polymeric substrate 10.

FIG. 2 illustrates that the multilayer structure can further comprise second polymeric substrate 30 and second infrared blocking layer 40 having gap 50 located in between polymeric substrate 10 and second polymeric substrate 30. Infrared blocking layer 20 can be in direct contact with first surface 12 of polymeric substrate 10 and second infrared blocking layer 40 can be in direct contact with a surface of polymeric substrate 30.

The polymeric substrate can comprise a thermoplastic polymer. The polymeric substrate can comprise a polycarbonate, a polyester (such as polyethylene terephthalate), a polyacetal, a polyacrylic, a polystyrene, a polyamide, a polyimide, a polyarylate, a polysulfone, a polyether, a polyphenylene sulfide, a polyvinyl chloride, polytetrafluoroethylene, polyetherketone, polyether etherketone, polyether ketone ketone, a polyacetal, a polyanhydride, a polyvinyl alcohol, a polyvinyl ketone, a polyvinyl halide, a polyvinyl nitrile, a polyvinyl ester, a polysulfonate, a polysulfide, a polythioester, a polyurea, a polyphosphazene, a polysilazane, polyvinyl butyral, or a combination comprising at least one of the foregoing. The polymeric substrate can comprise a polycarbonate, a polyester, or a combination comprising at least one of the foregoing. The polymeric substrate can comprise a polycarbonate.

“Polycarbonate” as used herein means a polymer or copolymer having repeating structural carbonate units of formula (1)

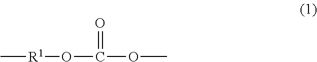

wherein at least 60% of the total number of R¹ groups are aromatic, or each R¹ contains at least one C₆₋₃₀ aromatic group. Specifically, each R¹ can be derived from a dihydroxy compound such as an aromatic dihydroxy compound of formula (2) or a bisphenol of formula (3).

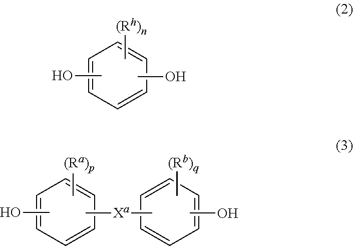

In formula (2), each R^{h} is independently a halogen atom, for example, bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an embodiment, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Some illustrative examples of dihydroxy compounds that can be used are described, for example, in WO 2013/175448 A1, US 2014/0295363, and WO 2014/072923. Specific dihydroxy compounds include resorcinol, 2,2-bis(4-hydroxyphenyl) propane (“bisphenol A” or “BPA”, in which each of A¹ and A² is p-phenylene and Y¹ is isopropylidene in formula (3)), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane, and 1,1-bis(4-hydroxy-3-methylphenyl)-3,3,5-trimethylcyclohexane (isophorone bisphenol).

The multilayer structure can comprise an ultraviolet light blocking layer, an abrasion resistant layer, or a combination comprising at least one of the foregoing disposed on a side of the infrared blocking layer opposite the polymeric substrate.

The ultraviolet light blocking layer can comprise a silicone, a polyurethane, an acrylic, a polyester, an epoxy, or a combination comprising at least one of the foregoing. The ultraviolet light blocking layer can comprise ultraviolet (UV) absorbing molecules, such as 4,6-dibenzoyl resorcinol (DBR), hydroxyphenyltriazine, hydroxybenzophenones, hydroxylphenyl benzotriazoles, hydroxyphenyltriazines, polyaroylresorcinols, 2-(3-triethoxysilylpropyl)-4,6-dibenzoylresorcinol) (SDBR), a cyanoacrylate, or a combination comprising at least one of the foregoing. The UV absorbing molecules can help to protect the underlying plastic panel and conductive mixture from degradation caused by exposure to the outdoor environment. Examples of UV absorbers are TINUVIN™ 329, TINUVIN™ 234, TINUVIN™ 350, TINUVIN™ 360 or UVINOL™3030.

The ultraviolet blocking layer can comprise a metal oxide (such as zirconium oxide, aluminum oxide (such as Al₂O₃), titanium dioxide, zinc oxide, iron oxide (such as Fe₂O₃), and the like, or a combination comprising at least one of the foregoing.

The ultraviolet light blocking layer can comprise one homogenous layer or can comprise multiple sub-layers, such as a primer layer and a topcoat layer. The primer layer can aid in adhering the topcoat to the plastic panel. The primer layer, for example, can comprise an acrylic, a polyester, an epoxy, or a combination comprising at least one of the foregoing. The topcoat layer can comprise polymethylmethacrylate, polyvinylidene fluoride, silicone (such as a silicone hardcoat), polyvinylfluoride, polypropylene, polyethylene, polyurethane, polyacrylate (such as polymethacrylate), or a combination comprising at least one of the foregoing. A specific example of an ultraviolet light blocking layer comprising multiple sub-layers is the combination of an acrylic primer (SHP401 or SHP470, available from Momentive Performance Materials, Waterford, N.Y.; or SHP-9X, available from Exatec LLC, Wixom, Mich.) with a silicone hard-coat (AS4000 or AS4700, available from Momentive Performance Materials; or SHX, available from Exatec LLC).

A variety of additives can be added to the ultraviolet light blocking layer, e.g., to either or both the primer and the topcoat, such as colorants (tints), rheological control agents, mold release agents, antioxidants, and IR absorbing or reflecting pigments, among others. The type of additive and the amount of each additive is determined by the performance required by the plastic glazing panel to meet the specification and requirements for use as a window.

The abrasion resistant layer can comprise one or both of an organic coating and an inorganic coating. The organic coating can comprise a urethane, an epoxide, an acrylate (for example, a silicone based acrylate), or a combination comprising at least one of the foregoing. The inorganic coating can comprise silicone, aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, glass, or a combination comprising at least one of the foregoing.

The abrasion resistant layer can be applied by deposition from reactive species, such as those employed in vacuum-assisted deposition processes, and atmospheric coating processes, such as those used to apply sol-gel coatings to substrates. Examples of vacuum-assisted deposition processes include plasma enhanced chemical vapor deposition, ion assisted plasma deposition, magnetron sputtering, electron beam evaporation, and ion beam sputtering. The abrasion resistant layer can be applied by a vacuum deposition technique plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, or a sol-gel coating process. Examples of atmospheric coating processes include curtain coating, spray coating, spin coating, dip coating, and flow coating, as well as combinations comprising at least one of the foregoing. The abrasion resistant layer can be applied via any technique or combination comprising at least one of the foregoing.

A specific type of PECVD process used to deposit the abrasion resistant layers comprising an expanding thermal plasma reactor is preferred. In an expanding thermal plasma PECVD process, a plasma is generated via applying a direct-current (DC) voltage to a cathode that arcs to a corresponding anode plate in an inert gas environment. The pressure near the cathode is typically higher than 20 kilopascals, e.g., close to atmospheric pressure, while the pressure near the anode resembles the process pressure established in the plasma treatment chamber of 2 to 14 pascal (Pa). The near atmospheric thermal plasma then supersonically expands into the plasma treatment chamber.

The reactive reagent for the expanding thermal plasma PECVD process can comprise, for example, octamethylcyclotetrasiloxane (D4), tetramethyldisiloxane (TMDSO), hexamethyldisiloxane (HMDSO), vinyl-D4, or another volatile organosilicon compound. The organosilicon compounds are oxidized, decomposed, and polymerized in the arc plasma deposition equipment, typically in the presence of oxygen and an inert carrier gas, such as argon, to form an abrasion resistant layer.

One or more of the layers in the multilayer substrate can comprise an additive to modify optical, chemical, and/or physical properties. Some possible additives include for example, mold release agents, ultraviolet light absorbers, flattening agents, binders, stabilizers (such as thermal stabilizers, and so forth), lubricants, plasticizers, rheology control additives, dyes, pigments, colorants, dispersants, anti-static agents, blowing agents, flame retardants, impact modifiers, among others, such as transparent fillers (e.g., silica, aluminum oxide, etc.). The above additives can be used alone or in combination with one or more additives.

The thermal stabilizer can comprise a phosphite, a phosphonite, a phosphine, a hindered amine, a hydroxyl amine, a phenol, an acryloyl modified phenol, a benzofuranone derivative, or the like, or a combination comprising at least one of the foregoing. Examples of thermal stabilizers are IRGAPHOS™168, DOVERPHOS™ S-9228, ULTRANOX™ 641.

The infrared blocking layer can be formed from an infrared blocking composition. The infrared blocking composition can comprise a curable prepolymer and the infrared blocking agent. The infrared blocking composition can comprise a curable prepolymer, the infrared blocking agent, and a solvent.

The infrared blocking composition can comprise 60 to 95 wt %, or 75 to 95 wt %, or 70 to 88 wt %, or 62 to 75 wt %, or 60 to 98 wt % of a curable prepolymer based on a total weight of the curable prepolymer and an infrared blocking agent. The infrared blocking composition can comprise 2 to 40 wt %, or 5 to 35 wt %, or 12 to 30 wt %, or 15 to 28 wt %, or 5 to 40 wt % of the infrared blocking agent based on a total weight of the curable prepolymer and the infrared blocking agent.

The infrared blocking composition can be prepared by mixing a prepolymer solution comprising 30 to 95 wt % of the prepolymer based on a total weight of the prepolymer solution with an infrared blocking solution comprising 10 to 95 wt % of the infrared blocking agent based on the total weight of the infrared blocking solution. The infrared blocking composition can comprise 10 to 90 wt % of prepolymer solution and 10 to 90 wt % of the infrared blocking solution both based on the total weight of the infrared blocking composition.

The infrared composition solvent can comprise propylene glycol monoether, isopropyl alcohol, propylene glycol monomethyl ether, propylene glycol methyl ether acetate, and the like, or a combination comprising at least one of the foregoing.

The multilayer structure can be formed by disposing the infrared blocking composition on the polymeric substrate; and curing the infrared blocking composition to form the layered structure. The disposing can comprise coating (such as bar coating, laminating, or extruding).

The multilayer structure can be formed by disposing the infrared blocking composition on a removable substrate; and curing the infrared blocking composition to form the infrared blocking layer; removing the infrared blocking layer; and laminating the infrared blocking layer onto the polymeric substrate to form the layered structure.

The multilayer structure can be formed by extruding the infrared blocking composition and the polymeric substrate. Following extrusion, the multilayer sheet can be laminated, for example, in a roll mill or a roll stack. The extruding can comprise extruding in a single or a twin screw extruder. The extruding can comprise adding the infrared blocking agent to the polymer matrix as a masterbatch and extruding the infrared blocking composition to form infrared blocking layer on the polymeric substrate.

An article can comprise the multilayer structure. The article can be a window. The window can be a vehicle window or a window in a building (such as an office building, a school, a store, a green house, a residential building, and the like). The article can be a lighting structure such as a headlamp, for example, for use in a vehicle. The vehicle can be a car, a truck, a boat, a train, a bus, an aircraft, and the like. The article can be a glazing.

The following examples are provided to illustrate the infrared blocking composition. The examples are merely illustrative and are not intended to limit devices made in accordance with the disclosure to the materials, conditions, or process parameters set forth therein.

### EXAMPLES

Adhesion testing was conducted according to ASTM D3002-07 where 5B is the rating for the best adhesion down to 0B that is the lowest adhesion rating.

The visible light transmission (Tvis) and the total solar transmission (Tts) were determined in accordance with ISO-9050.

Haze was determined in accordance with ASTM D-1003-00, Procedure A, measured, e.g., using a HAZE-GUARD DUAL from BYK-Gardner, using and integrating sphere (0°/diffuse geometry), wherein the spectral sensitivity conforms to the CIE standard spectral value under standard lamp D65.

Color was determined in accordance with ASTM D1003-00, Procedure B using a Macbeth 7000A spectrometer, D65 illuminant, 10° observer, CIE (Commission Internationale de L'Eclairage) (1931), and SCI (specular component included), and UVEXC (i.e., the UV component is excluded).

The IR blocking is equal to (the total IR transmittance (0.42456) minus the sum of the transmittance over the wavelengths of 780 to 2,500 nm) divided by the total IR transmittance times 100.

### Examples 1-13: Preparation of Infrared Blocking Layers

Five Infrared Blocking Compositions were Prepared by Mixing a Polymer solution of UVHC5000 comprising 45 wt % solids (commercially available from Momentive Co.) with a 20 wt % CTO dispersion. The infrared blocking compositions were bar coated onto a 0.5 mm thick polycarbonate sheet, heated for 30 minutes at 80 degrees Celsius (° C.), and UV cured using a Fusion UV model F300S-6 processor using H bulb, 300 W/in, at 5 m/min under ambient conditions. The polycarbonate sheet had a haze of 0.1%, a visible light transmission of 90%, and a total solar transmission of 86%.

The adhesion, haze, total solar transmission, and visible light transmission, were measured for the infrared blocking layers of Examples 2, 3, and 5 and are shown in Table 1. Transmission (dotted line) and the reflection (solid line) spectroscopy data over the visible IR range were measured for the infrared blocking layer of Example 5 and the results are shown in FIG. 3.

TABLE 1

| Example | 1 | 2 | 3 | 4 | 5 |
|---|---|---|---|---|---|
| Polymer solution (wt %) | 84 | 77 | 66 | 56 | 50 |
| CTO dispersion (wt %) | 16 | 23 | 34 | 44 | 50 |
| CTO in layer (wt %) | 7.8 | 11.7 | 18.6 | 25.9 | 30.8 |
| Adhesion | — | 5B | 5B | — | 5B |
| Haze (%) | — | 2.4 | 3.9 | — | 5.8 |
| Tvis (%) | — | 88 | 85 | — | 76 |
| Tts (%) | — | 79 | 72 | — | 56 |

Table 1 shows that the infrared blocking layers have good adhesion with the polycarbonate sheet and that they had good transparency and low haze. Table 1 further shows that, even for Example 5, where the visible light transmission is reduced to 76% and total solar transmission is reduced to 56%, still close to half of the solar radiation energy is effectively blocked by the infrared blocking layer.

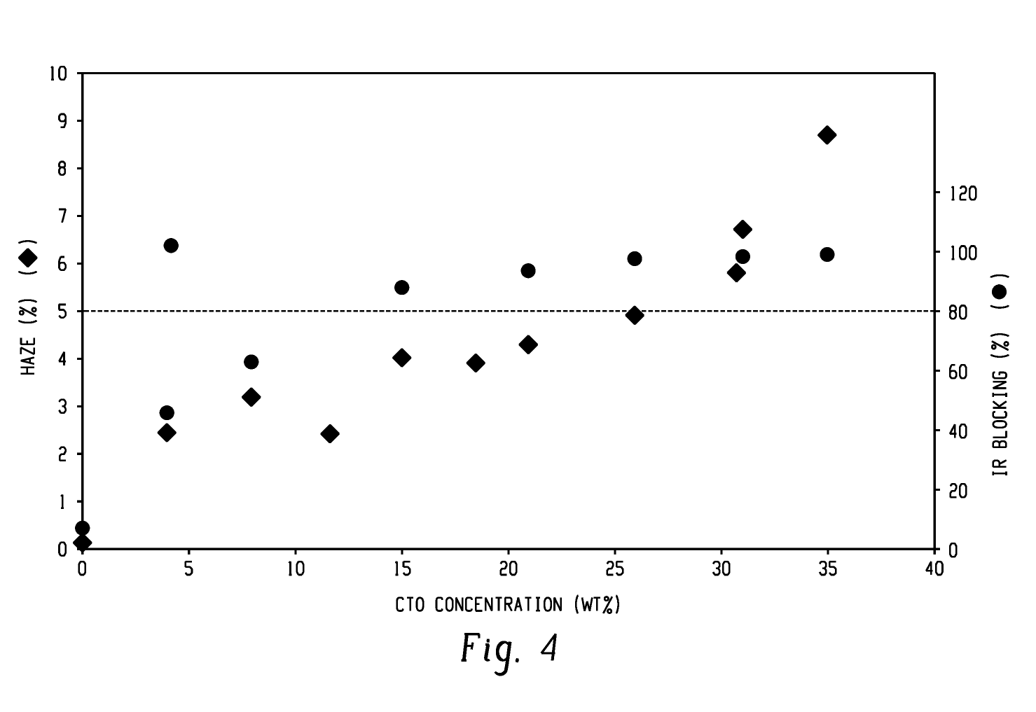

Eight further infrared blocking layers were prepared using the same coating method of Examples 1-5. The results are shown in Table 2 and the haze and IR blocking are illustrated as a function of CTO concentration in FIG. 4.

TABLE 2

| | Example | | | | | | | |
|---|---|---|---|---|---|---|---|---|
| | 6 | 7 | 8 | 9 | 10 | 11 | 12 | 13 |
| CTO in layer | 0 | 4 | 8 | 15 | 12 | 26 | 31 | 35 |
| (wt %) | | | | | | | | |
| Transmission | 92.5 | 86.9 | 83.4 | 75.0 | 69.4 | 62.7 | 57.2 | 55.0 |
| (%) | | | | | | | | |
| Haze (%) | 0.1 | 2.5 | 3.2 | 4.0 | 4.3 | 4.9 | 6.7 | 8.7 |
| Tvis (%) | 90.5 | 85.9 | 83.0 | 74.0 | 68.0 | 62.5 | 58.2 | 56.7 |
| Tts (%) | 88.2 | 73.6 | 66.8 | 54.7 | 50.0 | 46.7 | 44.7 | 43.9 |
| IR blocking | 7 | 46 | 63 | 88 | 94 | 97 | 98 | 99 |
| (%) | | | | | | | | |

Table 2 and FIG. 4 show that Examples 9, 10, and 11 were all capable of achieving a haze of less than or equal to 5% and an IR blocking of greater than or equal to 80%.

### Examples 14-16: Effect of the Polymer Matrix

Three infrared blocking layers were prepared using the same coating method of Examples 1-5 except that the curable prepolymer was varied. The curable prepolymer of Example 14 was the UV curable silicone based coating UVHC5000, the curable prepolymer of Example 15 was a thermally curable acrylate D1457, and the curable prepolymer of Example 16 was a UV curable acrylate DM353L, all commercially available from Momentive. Examples 14 and 16 comprised the solvent propylene glycol monomethyl ether (PGME).

TABLE 3

| Example | 14 | 15 | 16 |
|---|---|---|---|
| Curable prepolymer | UVHC5000 | D1457 | DM353L |
| CTO in layer (wt %) | 26 | 26 | 26 |
| Haze (%) | 4.9 | 30.9 | 45.9 |
| Transmission (%) | 62.7 | 72.6 | 61.2 |

Table 3 shows that Example 14 had a significantly lower haze of only 4.9% as compared to the haze of Examples 15 and 16 at the same CTO loading.

Set forth below are embodiments of the present composition, a layer formed therefrom, a layered structure comprising the layer, and methods of forming.

### Embodiment 1

An infrared blocking composition comprising: 60 to 95 wt %, or 60 to 98 wt % of a curable prepolymer based on a total weight of the curable prepolymer and an infrared blocking agent; 2 to 40 wt %, or 5 to 40 wt % of the infrared blocking agent based on a total weight of the curable prepolymer and the infrared blocking agent; wherein the infrared blocking agent comprises indium tin oxide, antimony tin oxide, fluorine tin oxide, tungsten oxide, or a combination comprising at least one of the foregoing.

### Embodiment 2

The composition of Embodiment 1, wherein the infrared blocking agent comprises the tungsten oxide; and wherein the tungsten oxide comprises potassium tungsten oxide (K(WO₃)₃), rubidium tungsten oxide (Rb(WO₃)₃), cesium tungsten oxide (Cs(WO₃)₃), thallium tungsten oxide (Tl(WO₃)₃), or a combination comprising one or more of the foregoing, preferably, the tungsten oxide comprises cesium tungsten oxide.

### Embodiment 3

The composition of any one of the preceding embodiments, further comprising an ultraviolet light blocking agent.

### Embodiment 4

The composition of Embodiment 3, wherein the ultraviolet light blocking agent comprises a benzotriazole, a 2-hydroxyphenyltriazine, a benzoate, a hydroxybenzophenone, or a combination comprising at least one of the foregoing.

### Embodiment 5

The composition of any one of the preceding embodiments, further comprising a binder, a flattening agent, a stabilizer, or a combination comprising at least one of the foregoing.

### Embodiment 6

The composition of any one of the preceding embodiments, wherein the curable prepolymer comprises a polysiloxane prepolymer, a polyurethane prepolymer, a polyacrylate prepolymer, or a combination comprising one or more of the foregoing.

### Embodiment 7

An infrared blocking layer formed from the composition of any one of the foregoing embodiments.

### Embodiment 8

The layer of Embodiment 7, wherein the infrared blocking layer is a 5B adhesion determined in accordance with ASTM D3002-07.

### Embodiment 9

The layer of any one of Embodiments 7-8, wherein the infrared blocking layer has a haze of less than or equal to 8%, or less than or equal to 3%, or less than or equal to 1%; wherein the haze is determined in accordance with ASTM D-1003-00, Procedure A, measured, e.g., using a HAZE-GUARD DUAL from BYK-Gardner, using and integrating sphere (0°/diffuse geometry), wherein the spectral sensitivity conforms to the CIE standard spectral value under standard lamp D65.

### Embodiment 10

The layer of any one of Embodiments 7-9, wherein the infrared blocking layer has a visible light transmission of greater than or equal to 75%.

### Embodiment 11

The layer of any one of Embodiments 7-10, wherein the infrared blocking layer has a total solar transmission of less than or equal to 75%.

### Embodiment 12

The layer of any one of Embodiments 7-11, wherein the infrared blocking layer comprises 5 to 35 wt % of the infrared blocking agent based on the total weight of the layer.

### Embodiment 13

The layer of any one of Embodiments 7-12, wherein the infrared blocking layer has a thickness of 1 to 100 micrometers, or 35 to 75 micrometers, or 1 to 10 micrometers.

### Embodiment 14

A layered structure comprising: a polymeric substrate; and the infrared blocking layer of any one of Embodiments 7-13 disposed on at least one surface of the polymeric substrate.

### Embodiment 15

The layered structure of Embodiment 14, wherein the layered structure comprises a first polymeric substrate comprising a first infrared blocking layer disposed on at least a first surface of the first polymeric substrate; a second polymeric substrate comprising a second infrared blocking layer disposed on at least a second surface of the first polymeric substrate; and a gap located in between the first polymeric substrate and the second polymeric substrate.

### Embodiment 16

The layered structure of any one of Embodiments 14-15, wherein the polymeric substrate comprises polycarbonate.

### Embodiment 17

The layered structure of any one of Embodiments 14-16, wherein the infrared blocking layer comprises a polysiloxane, a polyurethane, a polyacrylate, or a combination comprising one or more of the foregoing.

### Embodiment 18

The layered structure of any one of Embodiments 14-17, further comprising an ultraviolet light blocking layer, an abrasion resistant layer, or a combination comprising at least one of the foregoing disposed on a side of the infrared blocking layer opposite the polymeric substrate.

### Embodiment 19

An article comprising the layered structure of any one of Embodiments 14-18.

### Embodiment 20

The article of Embodiment 19, wherein the article is a window.

### Embodiment 21

A method of forming the layered structure of any one of Embodiments 14-18 comprising: disposing the infrared blocking composition on the polymeric substrate; and curing the infrared blocking composition to form the layered structure.

### Embodiment 22

A method of forming the layered structure of any one of Embodiments 14-18 comprising disposing the infrared blocking composition on a removable substrate; and curing the infrared blocking composition to form the infrared blocking layer; removing the infrared blocking layer; and laminating the infrared blocking layer onto the polymeric substrate to form the layered structure.

### Embodiment 23

The method of any one of Embodiments 21-22, further comprising depositing an abrasion resistant layer, wherein the depositing comprises a plasma-enhanced chemical vapor deposition process.

The terms “a” and “an” do not denote a limitation of quantity, but rather denote the presence of at least one of the referenced item. The term “or” means “and/or” unless clearly indicated otherwise by context. Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. “Optional” or “optionally” means that the subsequently described event or circumstance may or may not occur, and that the description includes instances where the event occurs and instances where it does not. The terms “first,” “second,” and the like, “primary,” “secondary,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation. The term “combination” is inclusive of blends, mixtures, alloys, reaction products, and the like. The endpoints of all ranges directed to the same component or property are inclusive of the endpoints, are independently combinable, and include all intermediate points, for example, ranges of “up to 25 wt %, or 5 to 20 wt %” are inclusive of the endpoints and all intermediate values of the ranges of “5 to 25 wt %,” such as 10 to 23 wt %, etc.

In general, the compositions, methods, and articles can alternatively comprise, consist of, or consist essentially of, any ingredients, steps, or components herein disclosed. The compositions, methods, and articles can additionally, or alternatively, be formulated, conducted, or manufactured so as to be devoid, or substantially free, of any ingredients, steps, or components not necessary to the achievement of the function or objectives of the present claims.

Unless specified to the contrary herein, all test standards are the most recent standard in effect as of the filing date of this application, or, if priority is claimed, the filing date of the earliest priority application in which the test standard appears. Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. An infrared blocking composition comprising:
60 to 98 wt % of a curable prepolymer based on a total weight of the curable prepolymer and an infrared blocking agent;
2 to 40 wt % of the infrared blocking agent based on a total weight of the curable prepolymer and the infrared blocking agent; wherein the infrared blocking agent comprises indium tin oxide, antimony tin oxide, fluorine tin oxide, tungsten oxide, or a combination comprising at least one of the foregoing.

2. The composition of claim 1, wherein the infrared blocking agent comprises the tungsten oxide; and wherein the tungsten oxide comprises potassium tungsten oxide (K(WO₃)₃), rubidium tungsten oxide (Rb(WO₃)₃), cesium tungsten oxide (Cs(WO₃)₃), thallium tungsten oxide (Tl(WO₃)₃), or a combination comprising one or more of the foregoing.

3. The composition of claim 1, further comprising an ultraviolet light blocking agent.

4. The composition of claim 3, wherein the ultraviolet light blocking agent comprises a benzotriazole, a 2-hydroxyphenyltriazine, a benzoate, a hydroxybenzophenone, or a combination comprising at least one of the foregoing.

5. The composition of claim 1, further comprising a binder, a flattening agent, a stabilizer, or a combination comprising at least one of the foregoing.

6. The composition of claim 1, wherein the curable prepolymer comprises a polysiloxane prepolymer, a polyurethane prepolymer, a polyacrylate prepolymer, or a combination comprising one or more of the foregoing.

7. An infrared blocking layer formed from the composition of claim 1.

8. The layer of claim 7, wherein the infrared blocking layer has one or more of a 5B adhesion determined in accordance with ASTM D3002-07, a haze of less than or equal to 8%, a visible light transmission of greater than or equal to 75%, and a total solar transmission of less than or equal to 75%;
wherein the haze is determined in accordance with ASTM D-1003-00, Procedure A, measured, e.g., using a HAZE-GUARD DUAL from BYK-Gardner, using and integrating sphere (0°/diffuse geometry), wherein the spectral sensitivity conforms to the CIE standard spectral value under standard lamp D65.

9. The layer of claim 8, wherein the haze is less than or equal to 8%.

10. The layer of claim 7, wherein the infrared blocking layer comprises 5 to 35 wt % of the infrared blocking agent based on the total weight of the layer.

11. The layer of claim 7, wherein the infrared blocking layer has a thickness of 1 to 100 micrometers.

12. A layered structure comprising:
a polymeric substrate; and
the infrared blocking layer of claim 7 disposed on at least one surface of the polymeric substrate.

13. The layered structure of claim 12, wherein the layered structure comprises
a first polymeric substrate comprising the infrared blocking layer disposed on at least a first surface of the first polymeric substrate;
a second polymeric substrate comprising a second infrared blocking layer disposed on at least a second surface of the first polymeric substrate; and
a gap located in between the first polymeric substrate and the second polymeric substrate.

14. The layered structure of claim 12, wherein the polymeric substrate comprises polycarbonate.

15. The layered structure of claim 12, wherein the infrared blocking layer comprises a polysiloxane, a polyurethane, a polyacrylate, or a combination comprising one or more of the foregoing.

16. The layered structure of claim 12, further comprising an ultraviolet light blocking layer, an abrasion resistant layer, or a combination comprising at least one of the foregoing disposed on a side of the infrared blocking layer opposite the polymeric substrate.

17. An article comprising the layered structure of claim 12.

18. The article of claim 17, wherein the article is a window.

19. A method of forming the layered structure of claim 12 comprising:
disposing the infrared blocking composition on the polymeric substrate; and
curing the infrared blocking composition to form the layered structure.

20. A method of forming the layered structure of claim 12 comprising:
disposing the infrared blocking composition on a removable substrate;
and curing the infrared blocking composition to form the infrared blocking layer;
removing the infrared blocking layer; and
laminating the infrared blocking layer onto the polymeric substrate to form the layered structure.
